(19) United States
(12) Patent Application Publication
(10) Pub. No.: US 2007/0028684 A1
(43) Pub. Date: Feb. 8, 2007

(54) Device for measuring a filling level

(76) Inventor: Joachim Benz, Hausach (DE)

Correspondence Address: FAY KAPLUN & MARCIN, LLP, 15O BROADWAY, SUITE 702, NEW YORK, NY, 10038, US

(21) Appl. No.: 11/491,402

(22) Filed: Jul. 21, 2006

Related U.S. Application Data
(60) Provisional application No. 60/705,601, filed on Aug. 4, 2005.

(30) Foreign Application Priority Data
Aug. 4, 2005 (DE) 10 2005 036 846.8

(51) Int. Cl. G01F 23/30

(52) U.S. Cl. 73/314; 73/290 B

(57) ABSTRACT

The present invention relates to a device for measuring a filling level of a filling material, wherein the device comprises a receiving unit with such buoyancy properties that it floats on the surface of the filling material. The receiving unit measures the distance between the transmitting and receiving units by means of a distance measurement on the basis of a first signal that is transmitted by at least a first transmitting unit and received by the receiving unit, wherein the filling level can be determined from this measured distance.

### REFERENCE TO RELATED APPLICATIONS

This application claims the benefit of the filing date of German patent application No. 10 2005 036 846.8 filed Aug. 04, 2005 and of U.S. Provisional patent application No. 60/705,601 filed Aug. 04, 2005, the disclosure of which applications is hereby incorporated herein by reference.

### FIELD OF THE INVENTION

The present invention relates to a device and a method for measuring a filling level of a filling material. The invention specifically relates to a device and a method for measuring a filling level of a filling material by means of a distance measurement carried out by transmitting and receiving units.

### TECHNOLOGICAL BACKGROUND

In the measurement of filling levels such as, for example, the filling levels of industrial containers or ship tanks, it is common practice to utilize filling level measuring devices that measure filling levels by means of radar wave measuring methods. The basic principle of this method consists of transmitting waves from an antenna in the direction of the filling material, wherein the waves are reflected on the surface of the filling material and received again by a receiving unit. The distance between the filling material and the antenna and therefore the height of the filling level in the container can be determined by means of a transit time measurement, i.e., by measuring the time between the transmission and the reception of these pulses, in connection with the propagation speed of the waves. This measuring principle is disclosed, for example, in

Other known filling level measuring devices operate on the basis of lasers or ultra sound.

### SUMMARY OF THE INVENTION

Amongst other things, it may be an object of the present invention to provide an alternative device and an alternative method for measuring a filling level of a filling material.

This objective may be attained with a device and a method for measuring a filling level of a filling material that are realized in accordance with the independent claims.

One exemplary embodiment of the invention pertains to a device for measuring a filling level of a filling material, wherein the device comprises at least one receiving unit, wherein the at least one receiving unit is designed such that it floats on the surface of the filling material, and wherein the at least one receiving unit is designed for determining the filling level by means of a distance measurement on the basis of a first signal that is transmitted by at least one first transmitting unit and received by the at least one receiving unit.

Another exemplary embodiment of the invention pertains to a device for measuring a filling level of a filling material, wherein the device features at least one transmitting unit, wherein the at least one transmitting unit is designed such that it floats on the surface of the filling material, and wherein at least one receiving unit is designed for determining the filling level by means of a distance measurement on the basis of a signal that is transmitted by the at least one first transmitting unit and received by the at least one receiving unit.

Another exemplary embodiment of the invention pertains to a method for measuring a filling level of a filling material, wherein said method comprises the steps of providing at least one receiving unit that is designed such that it floats on a surface of the filling material and of determining the filling level by measuring the distance between the at least one receiving unit and at least one first transmitting unit on the basis of a first signal that is transmitted by the at least one first transmitting unit and received by the at least one receiving unit.

Another exemplary embodiment of the invention pertains to a method for measuring a filling level of a filling material, wherein said method comprises the steps of providing at least one transmitting unit that is designed such that it floats on the surface of the filling material and of determining the filling level by measuring the distance between the at least one transmitting unit and at least one receiving unit on the basis of a signal that is transmitted by the at least one transmitting unit and received by the at least one receiving unit.

Modern techniques for measuring filling levels are based on transmitting electromagnetic waves in the direction of the filling material surface and subsequently receiving the reflected waves in accordance with the radar wave principle. In this case, it is required to mount a device in the container through an opening and to provide the corresponding external connections, wherein the aforementioned procedures may be relatively complex (e.g., with respect to structural considerations). In addition, the reflection may result in interferences and faulty measurements that can lead to a significant deterioration of the measuring quality.

According to one exemplary aspect of the present invention, a receiving unit (or a transmitting unit) may be accommodated in a closed (or open) receptacle and float on the filling material due to its buoyancy properties such that the respective unit is always positioned along the line of the filling level of the filling material. The receiving unit may receive the signals or waves from transmitting units and determine a distance based on the transmitted information. Since these signals do not have to be transmitted onto the surface of the filling material from a certain direction, the transmitting unit may be positioned outside the container. Consequently, it is possible to measure the filling level in a closed container that does not contain additional openings for mounting a device for measuring the filling level. This may ensure an improvement with respect to safety considerations, particularly when measuring the filling level of explosive and highly toxic filling materials.

In addition, the device according to the invention may make it possible to realize a significantly simpler measuring set-up because already existing positioning systems can be utilized in one embodiment of the system for measuring a filling level according to the present invention. For example, the transmitting units may form satellites of a positioning system such as, for example, GPS or Galileo, the signals of which can be evaluated by the receiving unit and/or a connected evaluation or processor unit. A combination of GPS and Galileo may make it possible to increase the number of transmitters and therefore to achieve a higher resolution.

According to another exemplary embodiment of the invention, the device comprises a plurality of receiving units, wherein the receiving units have buoyancy properties that enable them to float on the surface of the filling material, and wherein the receiving units are designed for determining the filling level by means of a distance measurement on the basis of a signal that is transmitted by at least one first transmitting unit and received by the receiving units. In this embodiment, the receiving units may cover different regions of the filling material. When measuring the filling level of viscous or solid filling materials such as glue or other bulk materials, for example, it is possible for different peaks to form on the surface. The invention may make it possible to also detect or scan these different peaks. In addition, an average filling level or a (estimated) container content can be calculated from the varying heights of the different surface levels. The redundancy of the receiving unit also may make it possible to utilize another receiving unit in case one of these units fails.

According to another exemplary embodiment of the invention, sound waves, airborne sound waves, radio waves, microwaves, infrared waves and light waves are used for transmitting the signals. Waves with a slow propagation speed, for example, sound waves, may used for the measurement of short distances between the at least one receiving unit and the at least one transmitting unit.

According to another exemplary embodiment of the invention, the receiving unit is designed in such a way that the distance of the at least one transmitting unit from the at least one receiving unit can be determined, in particular, by measuring the transit time of the signal transmitted by the first transmitting unit. In this case, this first signal contains information concerning the time of transmission. This information in connection with information on the time at which the signal has reached the receiving unit and the propagation speed of the signal makes it possible to calculate the distance between the transmitting unit and the receiving unit. Since the measuring apparatuses frequently are sluggish and slow due to the rapidly propagating waves, the length of the signal can be extended, for example, with the aid of interference measurements or scanning measurements in order to significantly improve the measuring accuracy. In this case, it would also be possible to utilize laser techniques, for example, the Michelson interferometer.

According to another exemplary embodiment of the invention, the device furthermore features at least one first transmitting unit for transmitting a first signal that is received by the least one receiving unit. If the receiving unit only has one degree of freedom and can only be moved one-dimensionally, a distance to and a position of the receiving unit can be determined by means of the transmitting unit. The distance between the transmitting unit and the receiving unit is calculated by measuring the transit time of the signal in this case.

In order to three-dimensionally determine the position in space of the at least one receiving unit, it is necessary, for example, to determine two position coordinates such that only the coordinate in the direction of the degree of freedom is variable. In connection with the information on the geographic position of the transmitting unit, this may make it possible to exactly determine the position of the at least one receiving unit and therefore the filling level.

Furthermore, the device may comprise at least one second transmitting unit for transmitting a second signal that can be received by the at least one receiving unit, wherein the first transmitting unit is spaced apart from the second transmitting unit. In comparison with the above-described embodiment that features one transmitting unit only, the utilization of two transmitting units may still make it possible that the receiving unit may comprise two degrees of freedom and though to exactly determine the position if the receiving unit. Once the distances between the at least one receiving unit and the first and second transmitting units are determined, the position of the at least one receiving unit within a two-dimensional area results in the intersecting point of the two linear distances between the respective transmitting units and the receiving unit. In this case, one prerequisite for obtaining an intersecting point between the linear distances is information on the positions of the first and second transmitting units. The precision of the distance measurement may proportionally increase with the spacing between the first and second transmitting units. The third space coordinate of the receiving unit may be defined in the form of a fixed, known space coordinate.

In another exemplary embodiment, the device comprises at least one third transmitting unit for transmitting a third signal that can be received by the receiving unit, wherein the third transmitting unit is spaced apart from the first and the second transmitting unit. This arrangement may make it possible to determine all three space coordinates of the at least one receiving unit. In this case, the at least one receiving unit may have three degrees of freedom and be three-dimensionally movable in space. One prerequisite, however, is that the at least three transmitting units also need to be spaced apart in this case. In this embodiment, the at least one receiving unit may once again determine the distances to the transmitting units such that the current position of the at least one receiving unit within the three-dimensional space lies in the intersecting point of the three linear distances.

According to another exemplary embodiment of the invention, the at least one receiving unit is designed for being guided along a container wall. When measuring with one transmitting unit only, the receiving unit can be designed such that it is one-dimensionally guided on the container wall and, for example, movable in the vertical direction only. If the receiving unit can be moved one-dimensionally, the other two space coordinates can be defined. Consequently, the only unknown or variable space coordinate of the at least one receiving unit, for example, is its vertical position, wherein the position in space can be determined with only one signal transmitted by the transmitting unit.

According to another embodiment of the invention, the at least one receiving unit is realized such that it can be guided two-dimensionally. For example, if the receiving unit has two degrees of freedom and is arranged on the container wall in such a way that it can be moved horizontally or vertically, it is necessary to provide at least two transmitting units for determining the two variable space coordinates. The third space coordinate is defined in this case.

According to another embodiment of the present invention, the receiving unit can be moved on the container wall in a controlled fashion and along guides. This may make it possible, for example, to move the at least one receiving unit over elevations and depressions in the surface of the filling material in order to thusly detect and scan the surface structure of a filling material. Information on the surface character also may make it possible to calculate the filling material content. The at least one receiving unit may be equipped with sensors that automatically scan the surface of the filling material and move the at least one receiving unit. The sensors may consist of contact sensors, pressure sensors or optical sensors.

In another exemplary embodiment of the invention, the device comprises a processing unit for evaluating and controlling the signals, wherein the processing unit is designed for receiving and/or transmitting the signals.

According to another exemplary embodiment of the invention, the at least one receiving unit is designed in such a way that it is able to transmit signals to the processing unit and/or to the at least one transmitting unit. For example, the processing unit may receive a position of the at least one receiving unit and further evaluate the thusly received data. The transmission of the signals (and/or data) may be realized with the aid of different transmission techniques, for example, Bluetooth, infrared, WLAN or radio signal techniques.

In addition, a variety of information can be transmitted with the signals or data and processed, for example, time data, position data, geodetic coordinates, polar coordinates, cylindrical coordinates, spherical polar coordinates, geographic coordinates, distances from the transmitting unit to the receiving unit, distances from the container bottom and/or walls and timing data.

In an exemplary filling level measurement according to the invention, the position data of the at least one transmitting unit may be transmitted to the receiving or processing unit. In addition to the determination of the distance of the transmitting unit(s) from the receiving unit(s), it is possible to transmit the position data of the transmitting units if the position of the transmitting units in space is not defined. In addition, the variety of information of the signals can be transmitted to the processing unit that controls the device based on this information or additionally processes the information otherwise.

According to another exemplary embodiment of the invention, the at least one receiving unit comprises a timer. During the measurement of the distance between the transmitting unit and the receiving unit, time difference measurements or transit time measurements between the time of transmission and the time of reception of the signals may make it possible to precisely synchronize the system time such that the exact transit time of the wave between the time at which the signal is transmitted and the time at which the signal is received can be measured.

According to another exemplary embodiment, the at least one transmitting unit or each of the plurality of transmitting units comprises a timer. In yet another exemplary embodiment of the invention, the processing unit comprises a timer. The processing unit can measure the time values of the transmitting and receiving units and thusly synchronize or adjust the time values. In addition, only the processing unit may comprise a timer and define a common system time. Consequently, this embodiment makes it possible to centrally define a common system time for all transmitting and receiving units. Measuring inaccuracies can be significantly reduced in this fashion.

For example, digital clocks, quartz clocks and atomic clocks may be considered for use as timing elements.

According to another embodiment of the invention, the receiving unit and the processing unit are realized integrally and in one piece, i.e., in the form of a common component. Since the receiving unit and the processing unit can be realized in the form of one component, significant cost-savings as well as advantages in the utilization of the device can be achieved.

In another exemplary embodiment, the at least one transmitting unit is a satellite. In this case, the device can use already existing signals of conventional navigation systems. Instead of providing separate transmitting units that are mounted, for example, on a container surface, the at least one receiving unit can use signals from the navigation systems for the filling level measurement. These signals usually also contain information on the time of transmission of the signal such that the measurement of the distance to the receiving unit can be realized based on a transit time measurement. In addition, the signals contain information on the position of the transmitting unit or satellite such that the exact position of the receiving unit can be determined based on the distance.

Navigation systems that can be implemented in a system according to the invention and the signals of which can be received by the at least one receiving unit are, for example, NASDA, GPS, Digital-GPS, Local Area-DGPS, Wide Area-DGPS, WAAS-GPS, EGNOS-GPS, GLONASS-, Galileo-, MTSAT- or Beidou-signals.

According to another exemplary embodiment, the processing unit also provides a reference signal for compensating inaccuracies in the distance measurement. Inaccuracies in the distance measurement may occur, for example, due to inaccurate time measurements between the time of transmission and the time of reception. The processing unit is able to compensate these inaccuracies by making available a reference signal. The processing unit has information on its geographic position. In addition to the at least one receiving unit, the processing unit also measures its own geographic position based on the signals received from the at least one transmitting unit or satellite, respectively. If the measured position value deviates from the actual position value of the processing unit position, the magnitude of the error can be calculated based on this deviation. This error value can then be used for correcting the other measured values such that a significant improvement in the measuring accuracy is achieved.

It is also possible to improve the detection accuracy of the filling level measurement by carrying out a redundant distance measurement between the transmitting and receiving units, e.g., by measuring more distances than mathematically required for determining the filling level. Consequently, measuring inaccuracies can be eliminated by means of averaging or other signal evaluation techniques.

According to another exemplary embodiment, the processing unit and/or the receiving unit may receive a reference value from another reference station in order to correct measuring errors. For example, regional D-GPS (Differential-GPS) transmitting stations are frequently provided in order to transmit a reference signal for the correction of GPS signals.

According to another exemplary embodiment of the invention, the receiving unit, each transmitting unit and/or the processing unit comprises an energy supply. In this case, the energy supply may be realized in the form of accumulators, solar cells, batteries and/or a power pack unit.

According to another exemplary embodiment of the invention, an energy supply can be realized in the form of an electromagnetic transmission and/or oscillating circuits when the receiving unit contacts the container wall with the aid of a sliding contact. This allows a contactless energy transmission. In an embodiment in which the float is mechanically guided with the aid of a guide element, the energy supply for the float can also be realized by means of the guide element.

According to another exemplary embodiment of the invention, the device comprises at least one transmitting unit, wherein the at least one transmitting unit has such buoyancy properties that it floats on the surface of the filling material, and wherein at least one receiving unit is designed for determining the filling level by means of a distance measurement on the basis of a first signal that is transmitted by the at least one first transmitting unit and received by the receiving unit. In this exemplary embodiment, at least one transmitting unit is introduced into a container in order to transmit distance measuring signals to at least one receiving unit mounted, for example, on the container wall.

According to another embodiment of the method, a certain transit time of a signal transmitted by the at least one first transmitting unit is measured in order to determine the distance of the transmitting unit to the receiving unit.

According to another exemplary embodiment of the method, a certain transit time of a first and a second signal transmitted by at least a first and a second transmitting unit is measured in order to determine the distance of the transmitting unit to the receiving unit.

According to another embodiment of the method, a certain transit time of at least three signals transmitted by at least three transmitting units is measured in order to determine the distance of the transmitting unit to the receiving unit.

According to another exemplary embodiment of the invention, the receiving unit is guided on a wall, for example, a container wall. In this case, the receiving unit may be one-dimensionally, two-dimensionally or three-dimensionally guided on a wall, for example, a container wall.

According to another exemplary embodiment of the method, a signal is transmitted or received by means of a processing unit. In this case, information can be transmitted from the receiving unit or a transmitting unit to the processing unit, as well as from the processing unit to the receiving unit or the transmitting unit. This may make it possible, for example, to synchronize the system time and to measure certain system times.

According to another embodiment, the time difference of a signal between the transmission by the at least one transmitting unit and the reception of the signal by the receiving unit and/or the processing unit is measured, for example, by means of a timer. The system time can be defined centrally by a unit, for example, the processing unit. A centralized time management is also possible, in which case each unit, for example, each transmitting, receiving and processing unit, features an individual timer. The timers can be synchronized in this case.

According to another embodiment of the invention, signals and data are received by satellites.

According to another exemplary embodiment of the method, filling levels can be measured in open waters or containers, wherein a receiving unit is initially introduced into a filling material to be measured and the distance of the receiving unit to at least one transmitting unit is determined thereof, and wherein a filling level can be determined based on the determined distance between the receiving unit and the transmitting unit. In this case, a receiving unit may be introduced, for example, into an open water or an open container and the filling level can be determined by means of a processing unit without having to take certain precautionary measures.

Therefore, the invention provides a simple system for measuring the filling levels of open waters (for example, lakes, rivers, channels, breeding ponds, water reservoirs or an ocean). This exemplary system can also be realized in the form of a light-weight and portable measuring device such that filling levels can be measured at all times without significant expenditures. The absolute value of the ground or the soil may already be known, for example, from a reference measurement, or a reference can be established, e.g., in relation to the sea level or mean sea level (MSL), respectively. The total depth is frequently not relevant, in which case a relative measurement suffices because the only interesting aspect is the changing level or filling level of the filling material. When measuring a multi-component filling material (for example, a filling material with oil and water fractions), it is possible to provide a series of floats, the buoyancy properties of which are chosen such that one respective float is present at each boundary surface (e.g., water/oil and oivair). In this case, the partial filling levels of the individual mediums or fractions can be measured separately.

The embodiments of the device also apply to the method and vice versa.

The device and the method according to the invention therefore introduce a novel technique for measuring filling levels that represents a completely new approach in comparison with concepts known so far. The technical expenditure and therefore the costs can be reduced by determining the respective positions by means of a float element in an open container. In addition, it is possible to utilize already existing navigation systems, for example, GPS or Galileo, such that no separate transmitting units need to be provided for the position measurements. These new filling level measurement concepts therefore make it possible to determine filling levels more efficiently and less expensively.

If satellite technology is used for the distance measurement and therefore for the measurement of the filling level of a filling material in a container, it should be possible for electromagnetic waves to penetrate the container (for example, the container should be manufactured from an electrically insulating material). The container may be alternatively or additionally realized without a cover.

The measurement of the distance between the transmitting unit and the receiving unit may be carried out in a wireless fashion (e.g., based on phase information or transit time information of electromagnetic waves) or in a wire-bound fashion (e.g., by means of a transit time measurement of an electric signal transmitted via a conductor between the transmitting unit and the receiving unit). It is possible to utilize known information on the propagation speed of waves (sound or electromagnetic) or phase information (e.g., with interference of coherent radiation).

### SHORT DESCRIPTION OF THE DRAWING

In order to further elucidate and contribute to the better understanding of the present invention, embodiments thereof are described in greater detail below with reference to the enclosed figures. In the drawings:

FIG. 1 shows a schematic representation of an exemplary embodiment of an inventive device for measuring a filling level;

FIG. 2 shows another representation of an exemplary embodiment of an inventive device for measuring a filling level with reference to existing positioning systems;

FIG. 3 shows a schematic representation of one possible design of a processing unit;

FIG. 4 shows a schematic representation of a device for measuring a filling level by means of positioning systems, namely with reference to terrestrial reference points;

FIG. 5 shows a schematic representation of an exemplary embodiment of the inventive method, and

FIG. 6 and 7 show a schematic side view and a top view of a device for measuring a filling level that features a controllable receiving unit. Identical or similar components are identified by the same reference numerals in different figures. The figures show schematic illustrations that are not true-to-scale.

### DETAILED DESCRIPTION OF EXEMPLARY EMBODIMENTS

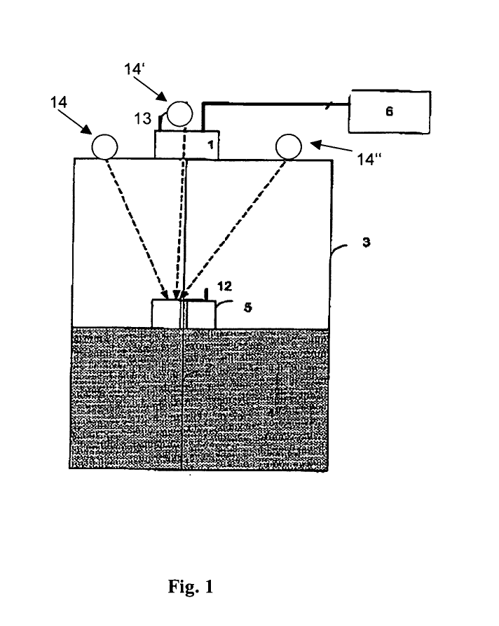

FIG. 1 shows is schematic representation of an inventive device for measuring filling levels.

In this case, a filling level of a filling material 4 is measured in a container 3. Due to its buoyancy properties, the receiving unit 5 is situated on (or near) the surface of the filling material 4. At least one transmitting unit 14 transmits signals to the at least one receiving unit 5 in order to determine a distance between the receiving unit 5 and the transmitting unit 14. The filling level or the container content can be calculated based on information on the position of the container bottom and on the position of the at least one receiving unit 5.

The device furthermore comprises a second, a third and/or a plurality of transmitting units 14′, 14″ that can be mounted, for example, on the container surface. The receiving unit 5 can be guided horizontally and/or vertically on a guide mechanism 2 arranged on the container wall.

For example, if the receiving unit 5 is guided vertically, it has one degree of freedom only. This means that the height of the filling material 4 can be ideally measured with only one transmitting unit 14 because only the vertical space coordinate is variable and the two other space coordinates are already defined by the guide 2 and therefore known.

If the receiving unit 5 is guided in a horizontal and a vertical direction, it is already possible to determine the height of the filling material with at least two transmitting units 14 and 14′ because the third space coordinate is already defined. The intersecting point between the respective linear distances between the receiving unit 5 and the first and second transmitting units 14, 14′, 14″ reflects the position of the receiving unit 5 in a two-dimensional space.

If the receiving unit 5 is not guided at all, it is able to freely move in the three-dimensional space on the surface of the filling material 4, i.e., at least three or more transmitting units 14, 14′, 14″ are required if the receiving unit has three degrees of freedom. The precision and the immunity to interferences of a filling level measurement increases proportionally with the number of transmitting units 14, 14′, 14″ provided. Regardless whether the receiving unit 5 is arranged in a guided or a non-guided fashion, the transmitting units 14, 14′, 14″ are spaced apart from one another in order to obtain intersecting points between the linear distances and therefore the position in space of the receiving unit 5.

The receiving unit 5 in the guide 2 can be controlled in order to thusly scan the surface of the filling material. In this case, the guide 2 features a mobile unit that moves the receiving unit over the surface of the filling material. This may makes it possible to detect all elevations and depressions of the filling material surface, particularly that of viscous filling materials or bulk materials.

The receiving unit furthermore comprises an antenna 12 for communicating with the transmitting units 14, 14′, 14″. A processing unit 1 with an antenna 13 may also be mounted, for example, on the container surface and communicate with a process control device 6. In this case, the processing unit is able to receive data on the elevations of the receiving unit 5 and of the container bottom and the filling level is subsequently calculated based on this data.

In order to measure the distance between the receiving unit 5 and the transmitting unit 14, 14′, 14″, the signals may transmit certain information that makes it possible to determine the distance. One option is based on transit time measurements of the transmitted signals. In this case, the difference between the time of transmission and the time of reception is measured and the distance is determined based on the constant or measurable propagation speed of the waves (e.g., electromagnetic waves or sound waves). In this case, the signals contain information on the time of transmission of the signal and the receiving unit 5 records the time at which the signal is received.

Therefore, it is necessary to define an exact system time that corresponds with the transmitting and receiving units. This can be realized, for example, by integrating highly precise atomic clocks into the transmitting 14, 14′, 14″ and receiving units 5 in order to exactly determine the distance. Another option for realizing a precise and corresponding system time consists of integrating a central timer into the processing unit, wherein this central timer precisely determines the time of transmission and the time of reception and defines a common system time.

Due to the slight time differences between the time of transmission and the time of reception, customary metrological interference measurements can be used for achieving a more precise determination of the position.

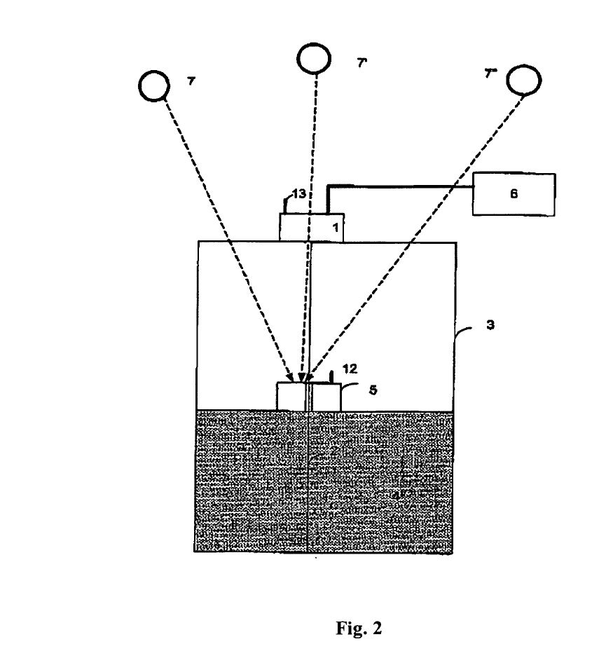

FIG. 2 shows another embodiment of the present invention. The filling level measuring device also comprises a container 3 with a filling material 4, wherein a receiving unit 5 lies on the filling material surface. In comparison with the exemplary embodiment shown in FIG. 1, signals of existing navigation systems are used in FIG. 2 rather than mounting special transmitting units 14, 14′, 14″ on the container surface. In this case, the transmitting units 7′, 7′, 7″ may consist of satellites that form part, for example, of the GPS system and/or the Galileo system. The receiving unit is able to receive the signals of the satellites and to determine the filling level thereof based on transit time measurements. A GPS satellite typically transmits the position of the transmitting satellite and the time at which the signal was transmitted. This enables the receiving unit 5 to exactly determine a position and therefore the height of the filling material.

In order to obtain more precise elevation data, terrestrial systems may also support the typical navigation techniques such as GPS and Galileo. For example, the Differential-GPS technique (DGPS) may make it possible to improve the accuracy. In this case, it is possible to mount another reference unit, for example, on the container surface, wherein the position of this additional reference unit is already known. This so-called stationary reference receiver has a known position and also measures its relative position with the aid of the satellite signals, wherein this reference receiver also compares its relative position with its known absolute position. The position error is determined thereof and local correction data is calculated. The correction data subsequently corrects the measured position data of the receiving unit 5. The stationary reference receiver may be integrated, for example, into the evaluation unit 1.

In the differential measuring method, it is also possible to correct several floats (e.g., in different containers) with a common reference.

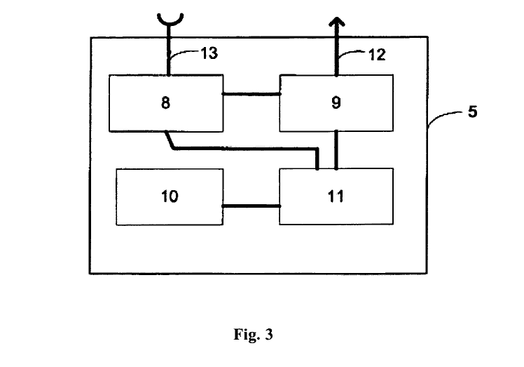

FIG. 3 shows a schematic representation of the receiving unit 5. In this exemplary embodiment, the receiving unit 5 may comprise, for example, a GPS receiver 8, a device 9 for transmitting position values, an energy supply and an optional control device for minimal power consumption 11.

The energy supply can be realized with accumulators, solar cells, batteries or via a connection to a power pack. If the receiving unit 5 is guided along a container surface, the energy supply can also be ensured with a sliding contact. It would also be conceivable to utilize energy supplies in the form of an electromagnetic transmission or inductive or capacitive oscillating circuits. These energy supplies can be utilized in the transmitting units 14, 14′, 14″, in the at least one receiving unit 5 or in the processing unit 1.

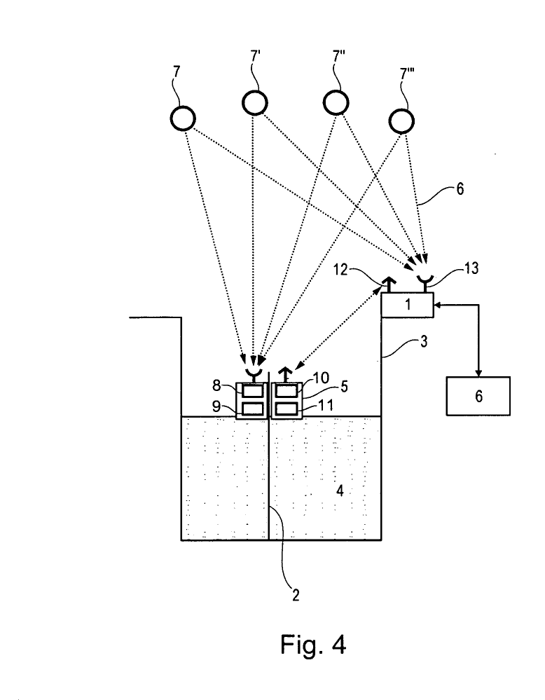

FIG. 4 shows a device for measuring filling levels, for example, in an open container. In order to increase the accuracy, the GPS-specific errors can be minimized if the reference point is known. An effective reference position minus an actual reference position is calculated by correcting all transit times with the aid of a correction factor. The reference unit does not have to be mounted directly on the container such that several receiving units 5 or floats 5 situated in different containers or basins can utilize the same correction factor of a common reference sensor.

The position coordinates of the reference unit are known. The reference unit simultaneously measures its own position coordinates with the aid of the navigation system. The correction factor can be calculated from the difference between the known position of the reference unit and the erroneous measuring value determined with the aid of the navigation system. Subsequently, the correction factor can be added to the erroneous values of the at least one receiving unit that were measured with the aid of the navigation system such that exact position coordinates of the receiving unit 5 are obtained.

Furthermore, the position coordinates are determined by four or more satellites 7′, 7″, 7′″, 7″″ in the exemplary embodiment according to FIG. 4. In addition to the improved accuracy achieved with the narrower error ranges, the stability of the system is significantly improved due to the redundancy of the transmitting units or satellites, respectively.

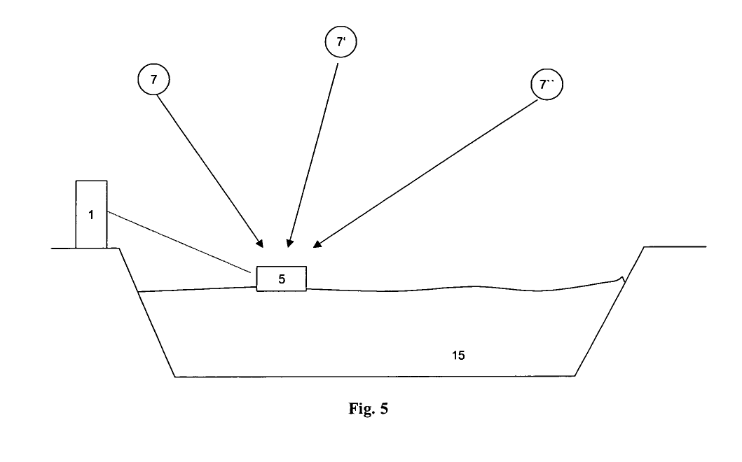

FIG. 5 shows an exemplary embodiment of the method. The inventive device makes it possible to easily measure filling levels of open waters or open containers or basins. In this case, a receiving unit 5 is introduced into an open water. The receiving unit 5 is able to precisely determine its position with the aid of conventional navigation systems, for example, GPS or Galileo. The precise filling level can be calculated by a processing unit 1 based on a reference value of the elevation of the bottom of the open water or the open container 15. The receiving unit 5 therefore may communicate with a transmitting unit 7, 14 or a processing unit 1 in a wireless or wire-bound fashion in order to carry out transit time measurements of waves for determining a distance. The total depth can be determined by means of a comparison with the mean sea level (MSL) or an initial measurement in the unfilled state. Since only a level change is frequently relevant, the information on the total depth is unnecessary. The sea level can be used as reference point for a measured elevation such that the determination of a reference point can be eliminated.

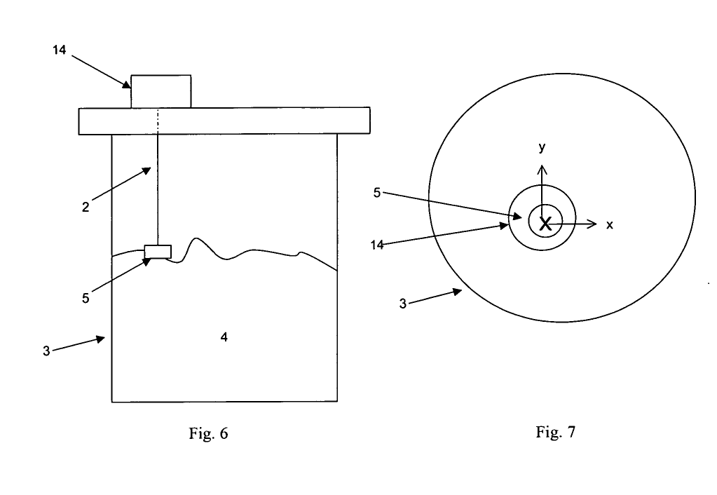

FIG. 6 and 7 show a device according to the present invention for measuring filling levels. The receiving unit 5 is connected to a movable guide unit 2. This guide unit 2 may be mounted, for example, on the ceiling of a container and move the receiving unit 5 over an inhomogeneous surface structure of the filling material surface, for example, in the x-direction and the y-direction. The movement in the z-direction of the receiving unit 5 is realized due to the hydrostatic buoyancy force and the principle of Archimedes, respectively. When measuring highly viscous liquids or bulk materials, the receiving unit 5 or the guide unit 2 may be equipped with sensors, for example, tactile sensors that scan the filling material surface and control the receiving unit in the z-direction. A transmitting unit 14 that moves with the guide unit 2 and therefore with the receiving unit 5 may be arranged above the receiving unit on the z-axis. This may make it possible to determine the distance in the direction of the z-axis and therefore the filling level. It would also be conceivable to carry out the measurement with a plurality of fixed transmitting units 14 or satellites 7 of a navigation system.

In summation, it should be noted that “comprising” does not exclude any other elements or steps, and that “a” or “an” does not exclude a plurality. It should furthermore be noted that characteristics or steps that were described with reference to one of the discussed embodiments can also be utilized in combination with other characteristics or steps of other embodiments discussed above.

What is claimed is:

1. A device for measuring a filling level of a filling material, the device comprising:
at least one receiving unit,
wherein the at least one receiving unit is designed such that it floats on the surface of the filling material, and
wherein the at least one receiving unit is designed for determining the filling level by means of a distance measurement on the basis of a first signal that is transmitted by the at least one first transmitting unit and received by the at least one receiving unit.

2. The device according to claim 1,
comprising a plurality of receiving units,
wherein the receiving units are designed such that they float on the surface of the filling material, and
wherein the receiving units are designed for determining the filling level by means of a distance measurement on the basis of signals that are transmitted by at least one first transmitting unit and received by the receiving units.

3. The device according to claim 1,
wherein the signal(s) has/have waves that are selected from the group consisting of electromagnetic waves, sound waves, radio waves, microwaves, infrared waves and light waves.

4. The device according to claim 1,
wherein the at least one receiving unit is designed in such a way that the distance of the at least one first transmitting unit to the at least one receiving unit can be determined by means of a transit time measurement of the signal transmitted by the at least one first transmitting unit.

5. The device according to claim 1, further comprising the at least one first transmitting unit for transmitting the first signal that can be received by the at least one receiving unit.

6. The device according to claim 1, further comprising at least a second transmitting unit for transmitting a second signal that can be received by the at least one receiving unit,
wherein the at least one first transmitting unit is arranged such that it is spaced apart from the at least one second transmitting unit.

7. The device according to claim 6, further comprising at least a third transmitting unit for transmitting a third signal that can be received by the at least one receiving unit,
wherein the at least one third transmitting unit is arranged such that it is spaced apart from the at least one first transmitting unit and spaced apart from the at least one second transmitting unit.

8. The device according to claim 1, further comprising a container, wherein the at least one receiving unit is designed for being guided along a wall of the container.

9. The device according to claim 8, wherein the at least one receiving unit is designed for being guided one-dimensionally.

10. The device according to claim 8, wherein the at least one receiving unit is designed for being guided two-dimensionally.

11. The device according to claim 1, further comprising a processing unit for evaluating and/or controlling the signal(s),
wherein the processing unit is designed for receiving and/or for transmitting and/or for evaluating the signal(s).

12. The device according to claim 1, wherein the first signal that is transmitted by the at least one first transmitting unit and received by the at least one receiving unit can be transmitted in a wireless fashion.

13. The device according to claim 1, wherein the signal(s) can be transmitted by utilizing a transmission technique that is selected from the group consisting of a Bluetooth radio signal technology, infrared radio signal technology and WLAN technology.

14. The device according to claim 1, wherein the signal(s) contain(s) at least one information that is selected from the group consisting of time data, position data, geodetic coordinates, polar coordinates, cylindrical coordinates, spherical polar coordinates, geographic coordinates, distance of the at least one receiving unit and/or the least one transmitting unit from a wall and/or from a bottom of the container and timing data.

15. The device according to claim 1, wherein the at least one receiving unit comprises a timer.

16. The device according to claim 1, wherein the at least one first transmitting unit comprises a timer.

17. The device according to claim 11, wherein the processing unit comprises a timer that defines a common system time for each of the at least one first transmitting unit and for each of the at least one receiving unit.

18. The device according to claim 15, wherein the timer is selected from the group consisting of digital clocks, quartz clocks and atomic clocks.

19. The device according to claim 11, wherein the processing unit is integrated into the at least one receiving unit.

20. The device according to claim 1, wherein at least one of the at least one first transmitting unit is a satellite.

21. The device according to claim 1, wherein the at least one receiving unit utilizes a navigation system.

22. The device according to claim 1, wherein the at least one receiving unit utilizes a satellite-assisted navigation system.

23. The device according to claim 21,
wherein the navigation system is selected from the group consisting of NAVSTAR-GPS, Digital-GPS, Local-Area DGPS, Wide-Area DGPS, WAAS-GPS, EGNOS-GPS, GLONASS, Galileo, MTSAT and Beidou.

24. The device according to claim 1, wherein the at least one receiving unit and/or the at least one first transmitting unit and/or the processing unit comprises an energy supply.

25. The device according to claim 24, wherein the energy supply is selected from the group consisting of accumulators, solar cells, batteries and a power pack.

26. The device according to claim 24, wherein the energy supply is realized with the aid of a sliding contact, by means of electromagnetic transmission and/or by means of oscillating circuits.

27. A device for measuring a filling level of a filling material, the device comprising:
at least one transmitting unit,
wherein the at least one transmitting unit is designed such that it floats on the surface of the filling material, and
wherein at least one receiving unit is designed for determining the filling level by means of a distance measurement on the basis of a signal that is transmitted by the at least one first transmitting unit and received by at least one receiving unit.

28. A method for measuring a filling level of a filling material, said method comprising the steps of:
providing at least one receiving unit that is designed such that it floats on a surface of the filling material, and
determining the filling level by measuring the distance between the at least one receiving unit and at least one first transmitting unit on the basis of a first signal that is transmitted by the at least one first transmitting unit and received by the at least one receiving unit.

29. The method according to claim 28, further comprising the step of measuring a transit time of the first signal that is transmitted by the at least one first transmitting unit in order to determine the distance of the at least one first transmitting unit from the at least one receiving unit.

30. The method according to claim 28, further comprising the step of measuring the transit times of a first signal and a second signal that are transmitted by the at least one first transmitting unit and by at least one second transmitting unit in order to determine the distance of the transmitting units from the at least one receiving unit.

31. The method according to claim 28, further comprising the step of mechanically guiding the at least one receiving unit one-dimensionally in a container that contains the filling material.

32. The method according to claim 28, further comprising the step of measuring a time difference of the signal(s) between the transmission by the at least one first transmitting unit and the reception by the at least one receiving unit with the aid of a timer.

33. The method according to claim 28, further comprising the step of defining a common system time for each of the at least one first transmitting unit and for each of the at least one receiving unit.

34. The method according to claim 28, further comprising the step of receiving the signal(s) from satellites in the form of the at least one first transmitting unit.

35. The method according to claim 28, wherein the filling material consists of the water of an open water.

36. A method for measuring a filling level of a filling material, said method comprising the steps of:
providing at least one transmitting unit that is designed such that it floats on the surface of the filling material, and
determining the filling level by measuring the distance between the at least one transmitting unit and at least one receiving unit on the basis of a signal that is transmitted by the at least one transmitting unit and received by the at least one receiving unit.
